(19) United States
(12) Patent Application Publication
(10) Pub. No.: US 2004/0136276 A1
(43) Pub. Date: Jul. 15, 2004

(54) Time studies chronometer with generic descriptions

(76) Inventor: Ronald Jon Lander, Bainbridge Island, WA (US)

Correspondence Address: Jeffrey T. Haley, GRAYBEAL JACKSON HALEY LLP, Suite. 350, 155-108th Avenue N.E., Bellevue, WA, 98004-5901, US

(21) Appl. No.: 10/644,694

(22) Filed: Aug. 20, 2003

Related U.S. Application Data
(63) Continuation-in-part of application No. PCT/US02/05378, filed on Feb. 20, 2002.
(60) Provisional application No. 60/270,137, filed on Feb. 20, 2001.

(51) Int. Cl. G04C 17/00; G04C 19/00

(52) U.S. Cl. 368/239

(57) ABSTRACT

A time studies chronometer presents to a user generic descriptions for the user to choose from to describe each task observed by the user. By employing generic descriptions, data collected for each task is automatically given a tag (meta-data) so that all tasks of a single generic description can be processed together for presentation or computation. Tasks are organized in a hierarchy of processes (task series) which are organized in a hierarchy of studies. For the process description and the study description the user is also presented with generic descriptions from which to choose so that the process data and the study data also have tags (meta-data) that can be used for processing the data. The use of pre-specified generic descriptions greatly speeds up the time study process.

This application claims priority from U.S. Provisional Application 60/270,137 filed Feb. 20, 2001.

### BACKGROUND

A time study (time and motion study) is a procedure used to determine the time it takes a person to do a specified series of tasks with a specific quality. A time study is used to determine the most effective ways for an organization to use the basic factors of production, people, machines, materials, information, and energy to make or process a product or produce a service. Examples include:

Measurement for operations:

Routing sheets

Floor layouts

Material handling

Machine utilization studies

Development and maintenance of labor standards

Development and application of appropriate production standards for:

Manufacturing operations

Design

Implementation

Maintenance of incentive programs

Operational efficiencies

Cost reduction programs

Development of databases to assess and optimize:

Human Factors

Efficiency

Safety

Evaluation of opportunities for performance improvement:

Quantify potential cost savings opportunities

Help implement cost effective programs

Increase productivity and efficiency while reducing costs

The first industry recognized time study used for process improvement was in 1878 by Fredrick Taylor in a steel mill in Philadelphia. Tools used for that study were a stopwatch and paper. At that time, the techniques required hand entry of observed elements; hand transferring of timed results, and a manual analysis of the data. That was over 122 years ago. This time study method of stopwatch and paper remains the industry standard today, with the exception that the data may now be analyzed by computer.

Time studies require measuring the duration of each task in a series of tasks, writing a description of the task to identify it, and writing down a time duration for each task. Sometimes notes or characterizations must be made about a task. The data is then transferred to data analysis sheets or a computer for analysis and presentation. Time spent recording a description of the task, noting a characterization of the task, and recording time is time not spent observing. Large amounts of time are required to enter task descriptions and characterizations, transfer the data to a computer or sheets of paper, and generate useful reports. Also, time amounts for similar tasks or otherwise related tasks are not grouped together for analysis, so this must be done by a person specifying the groupings. In other words, there are few tags or meta-data that describe the data.

### SUMMARY OF THE INVENTION

The invented system greatly reduces time required for setup, data collection, and building reports the most time consuming, error-ridden and expensive part of traditional time studies. It also adds computer-usable tags to the data to facilitate further analysis.

The invented time studies chronometer preferably comprises a portable, handheld computer with a touch screen programmed to be a continuously running chronometer with a plurality of alternative generic task description options and one or more generic characterization options for each task. The computer captures data files which store the timed interval of each task. The task description options are preferably buttons or icons on the touch screen that generically describe a task. The chronometer times the specific task or tasks as the time from one mark time button press at a transition between tasks to the next mark time button press at a transition between tasks. The clock continuously runs for the duration of the study.

The gathering of observed data is preferably accomplished through the use of easily identifiable, on-screen task description icons on a handheld touch screen PC designed for use in an industrial environment. These icons are specifically tailored to include all relevant and observed elements in the time study process. The touch screen icons are immediately recognizable, enabling quick association with the observed elements and can be more immediately recorded by the observer. With the invented system, the duration of an element that can be recorded accurately is 1.5 seconds, which is enough time for an observer to select a task description icon, select a characterization icon for the task, and press the mark time button.

The characterization options are preferably implemented by giving the user a choice of icons that represent possible characterizations. When an icon is pressed on the touch screen, it assigns the characterization that it represents to the task currently being timed. The apparatus might include characterization options to identify any generic characterization or quality of a task. The characterization most commonly desired is “value added” or “non-value added”. However, any characterization can be associated with any task, such as the inspection method used to verify successful completion of the task.

By using on-screen generic icons that are easily identifiable and manipulated when used with a handheld touch screen PC to identify tasks and characterize tasks, less time is required to input the observed information. This in turn, means more time is spent observing the subject. Also, no time is spent making a list of the tasks to be studied before the study is commenced. The list is generated on the fly. Even though the icons are carefully selected to represent all likely tasks to be encountered in a manufacturing facility, an “Unknown Element” icon can be pressed if an unrepresented task is observed, and an appropriate description can be entered later for the task using the keyboard or other input method.

By presenting the user with many optional generic task descriptions, two important objectives are achieved. Time is saved for the observer, as mentioned above, and data analysis can be automated. A single generic description icon is used for many tasks, allowing automated processing of data from tasks by using the description as a tag or meta-data. Similarly, by offering the user a choice among generic characterizations for a task, characterizations can be used as a tag or meta-data to allow analyses of tasks that share the same generic description.

To allow analysis of data at a second level, series of tasks that are performed one after another are functionally grouped into “processes” or “task series” and each process is given a description by selecting among generic pre-specified descriptions for the process or series of tasks. Consequently, time data is automatically captured for the process, from beginning to end, and processes which have the same generic description are automatically grouped together for potential subsequent processing.

Similarly, each time study is given a generic description by the user selecting one of many generic descriptions so that, as data is collected from many time studies, the data from similarly described time studies is automatically grouped for subsequent processing or analysis.

In one aspect, the invention is a time studies chronometer with a changeable display which presents to a user a plurality of generic task description options for each observed task and accepts input from a user to select one of the task description options for the task. In another aspect, the invention is software for a computer, that is, a data carrier containing a computer program which, when run on a general purpose computer, causes the computer to be the chronometer just described. The data carrier may be a memory device, such as a disk or memory chip or any other physical portable memory, or it may be an electronic signal such as transmitted over a computer network. The set of generic task descriptions are typically loaded into the memory of the chronometer by copying from an external memory, such as a disk, coupled to the chronometer for uploading the option descriptions.

In another aspect, the invention is a time studies chronometer (or computer software therefore) that presents on a display generic task rating or characterization options to characterize a task and accepts input from a user to select one of the task characterization options. Preferably, the options are presented on the display with one or more icons on a touch screen. Such a characterization (rating value) might be “value added” or “no value added”. Another characterization might be a method of inspection used to verify that a task was completed successfully and the generic characterizations might be “sight”, “touch”, or “device” (if a device is used for the inspection method, such as an electrical continuity tester).

In another aspect, the invention is a time studies chronometer (or software therefore) with a changeable display that collects data for tasks where the tasks are organized into task series so that the data can be analyzed at both the task level and the series level. That is, for a task series to be observed as part of a time study, the display presents task series description options to describe the task series and, upon receipt of input from a user selecting a task series, the display presents task description options to describe a task and the chronometer then accepts input from a user to select one of the task description options for the task. In this aspect of the invention, the descriptions need not be generic but might instead have been to specifically describe the tasks and processes to be studied.

The two levels of data just described may be further embedded in a third level of data at the time study level by, before presenting a plurality of task series description options to a user, the display presents a plurality of study description options to describe the study to be done and the chronometer accepts input form a user to select one of the study description options.

It has become common within industry, in particular to meet ISO 9000 requirements, to print and display a worksheet document containing work instructions for a task to be done. The worksheet includes standard text which is the same for all worksheets, a task name, a task description, and a typical time duration for the task. In another aspect, the invention is a method for generating such a worksheet by setting up the standard text for each worksheet, receiving a task name and description for a task, receiving a marked time event designating commencement of the task and then a marked time event designating finish of the task, storing in a memory the task name and description and, associated with the name and description, time data indicating duration of the task, and then generating data representing a worksheet document for the task comprising the standard text, the task name and description, and duration of the task.

If a task characterization was collected during the time study noting the inspection method used with the task, the inspection method can also be automatically added to the worksheet document. Further, the worksheet document can be set up to receive digital photographic data so that when the document is displayed or printed, a photograph of how to perform the task is included.

### BRIEF DESCRIPTION OF THE FIGURES

FIGS. 1-7 show screen displays generated by the system during the process of collecting data of a time study.

FIGS. 8 and 9 show two reports automatically generated by the system.

### DETAILED DESCRIPTION

The invented system can be implemented with any general purpose computer. Preferably, it is implemented with a hand held computer with a touch screen for both output and input. The same hand-held touch screen computer can be used in a variety of industrial, office or home environments with the use of appropriate software for each study. An effective operating system for the computer is Microsoft Windows CE®. Suitable hardware includes but is not limited to any one of the following, Fujitsu PenCentra®, HP Jornada®, NEC MobilePro 78®, Two Technologies TouchLite® and Hitachi ePlate®. In a factory where the time studies observer (analyst) can see operations from a desk chair, such as with video cameras, the system can be implemented with a desktop PC and a mouse for input. Timer data collection is merely to the nearest second, which presents no problems for ordinary operating systems on hand held or other personal computers.

A time studies application software module provides the generic task description icons for the types of tasks to be studied, as well as appropriate characterization icons, process description icons, and study description icons. For example, different modules would apply to the following industries: manufacturing, assembly, transport/delivery, traffic monitoring (a generic description of each vehicle can be captured along with a time stamp), garment, food processing, warehousing, time management/billing, customer service, and hospitality/cruise industries.

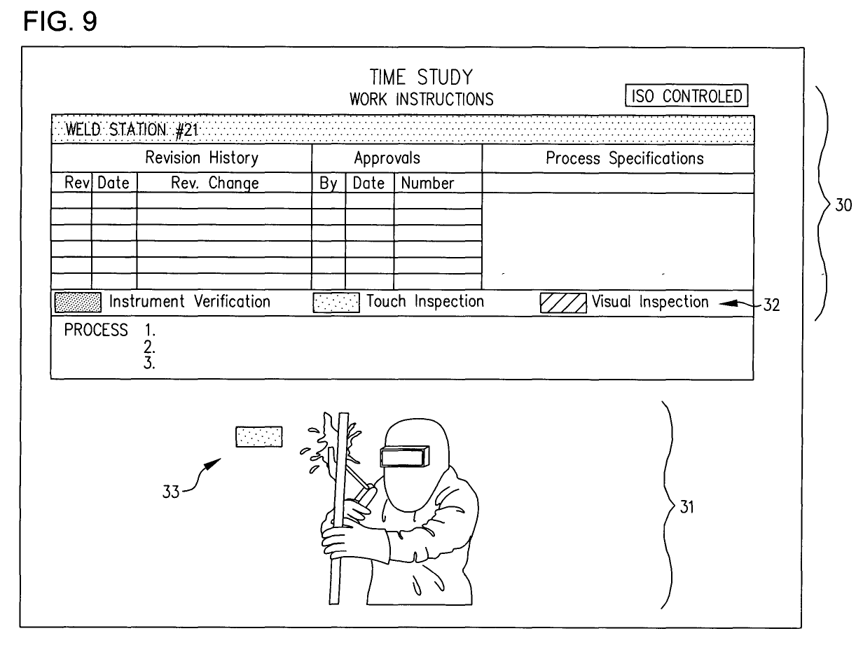

After the data is gathered, it is analyzed and compiled by an analysis module that is run by either the hand held itself or run on a desktop or laptop PC to which the data is transferred. In either case, a fully compiled, set of forms, graphs, and charts is automatically generated using the meta-data provided by the generic task descriptions, task characterizations, process descriptions, and study descriptions. They are automatically ready for presentation on paper or screen. See FIGS. 8 and 9.

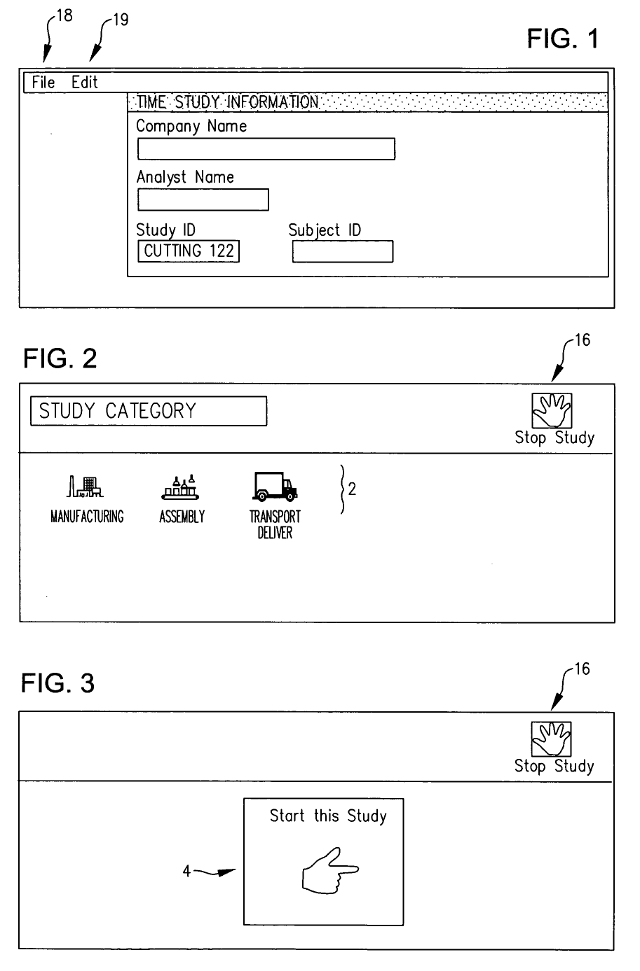

The process of performing a time study with the system works as follows. After starting the time study program, the observer conducting the time study (analyst) first inputs the necessary information to accurately identify the study as shown in FIG. 1. The display then presents the image shown in FIG. 2. Next, he selects, from a plurality of presented options for study categories (generic study descriptions), each represented by an icon 2, as shown in FIG. 2. The study descriptions shown in FIG. 2 include words as well as icons. Alternatively, only words or only icons could be used.

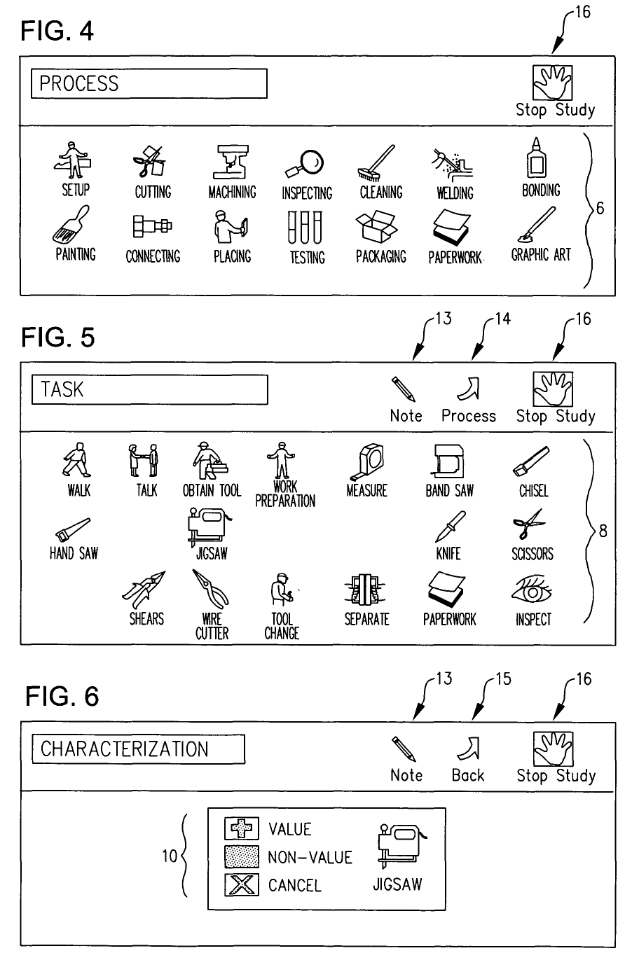

The display then presents the image shown in FIG. 3. Next, when the person performing the tasks starts the process, he starts a timer (run by software that checks the clock in the computer) by selecting a presented start icon 4, as shown in FIG. 3, and observes the person (subject) performing the tasks. The display then presents a set of optional generic task series (process) descriptions in the form of icons 6 as shown in FIG. 4. The task series descriptions shown in FIG. 4 include words as well as icons. Alternatively, only words or only icons could be used.

Once the observer discerns what the subject is doing, he selects one of the icons 6 describing a process containing the group of tasks and/or subtasks (series of tasks) that he is observing. The display then presents a set of optional generic task descriptions in the form of icons 8 as shown in FIG. 5. The task descriptions shown in FIG. 5 include words as well as icons. Alternatively, only words or only icons could be used.

The observer selects the appropriate task icon to describe the first task. The display then presents a set of task characterization options in the form of icons 10 as shown in FIG. 6 which, in the example shown in FIG. 6, characterize the task as value adding or non-value adding. The task characterizations shown in FIG. 6 include words as well as icons. Alternatively, only words or only icons could be used.

Then the observer presses a task characterization icon that causes data for the first task to include the characterization. Next, if the embodiment is equipped with an additional characterization option, the observer records an additional characterization of the task. For example he may characterize a method of inspection used to verify that the task was completed properly as “sight” (“visual”), “touch”, or “device” (“instrument”).

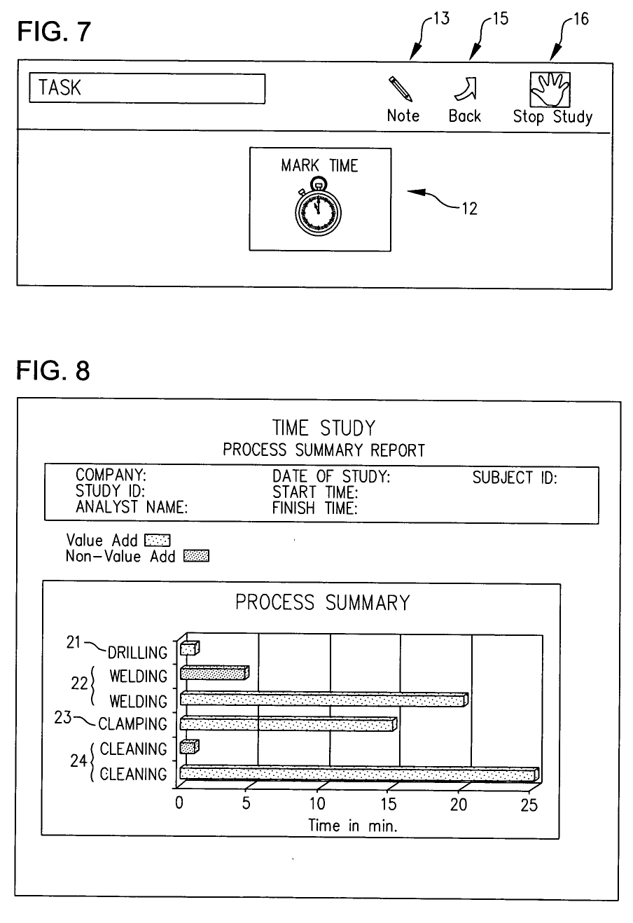

The display then presents a mark time button 12 as shown in FIG. 7. Finally, upon finish of the first task and commencement of a new task, the observer presses the mark time button to stop timing the first task and start timing the next task.

The display again presents the set of optional generic task descriptions in the form of icons 8 shown in FIG. 5 so the observer can select an icon to describe the new task. If the user has finished the process (series of tasks) and begun the first task of a new process, the observer presses a “back”/“up” button 14 (labeled “Process” in FIG. 5 and labeled “Back” 15 in other figures) to return to the process selection screen shown in FIG. 4. Even if the newly started process would use the same generic task series description as the prior process, it is important for the observer to return to the screen of FIG. 4 and reselect the same process icon so the time studies chronometer can capture timing data to mark the end of the prior process and commencement of the next process (of the same generic description).

Whenever the study should be ended and the study timer stopped, the observer presses any one of the stop study buttons 16 as shown in FIGS. 4-7. The display then returns to FIG. 1. The study data is saved as a file in a file system on the chronometer. If the observer wishes to recommence the study, the data file can be opened using the File tab 18 shown in FIG. 1 and the next screen presented is then FIG. 3.

It is important to note that the above description of the levels of organization in the data collected are not intended to limit other possible organizational arrangements, rather it is merely illustrative of one particular embodiment.

Some time study methods use a narrow definition of a task. Some tasks that might not be included within a narrow definition are listed in Table 1 below. Inclusion of these tasks improves the quality of the data captured by the time study.

TABLE 1

| Task Name | Description |
|---|---|
| Talk | Communication with one or more. |
| Walk | Walking without carrying materials. |
| Running | Running. |
| Search | To randomly look. |
| Observe-Stare | Determining next task or sequence |
| Waiting | Pause, halt or delay an activity or task. |
| Paperwork | Starting or completing forms, drawings, data gathering |
| | or any computer work. |
| Personal | Non-planed activity such as going to the bathroom, |
| | phone call or smoke break. |
| Break | Planned work stoppage. |
| Lunch | Planned eating time. |
| Unknown element | Unable to identify or categorize element or elements |

The last task listed above is required in this system because all of the tasks that are pre-specified in the system are generic. That is, they would be suitable descriptors for many specific tasks that are conducted in a typical process of the type to be studied. If the worker (or object of study) begins a task or process that does not have a pre-specified generic description, the observer can specify “unknown element” as the task or process. While the task is being conducted or after the task is completed, the observer can enter a textual description of the task. In a preferred embodiment, there is a “notes” field that can be activated pressing the note button 13 in FIGS. 5-7 in which the observer can enter any notes associated with any task. A task description for an unknown task can be entered in the notes field while the task is being performed.

A consequence of using “unknown element” to describe a task or process is that the data for this task or process cannot be automatically grouped by the system with other data for similar tasks or processes. If such grouping is appropriate, the observer must do it manually. Alternatively, after the task or process has been completed, the observer can edit the time study data file by selecting the edit command 19 shown in FIG. 1 to then select one of the generic task or process descriptions for the task or process. As another alternative, if the observer has used the “unknown element” generic description to identify more than one task or process and these are all similar to each other, the observer can create a new name, a new description, and even select from standard icons an icon to go with the task or process for future use. The data for the newly defined generic task or process is now grouped by the task or process name for further automatic processing together.

If the observer makes an error in a process, there is no way to “undo” the selection of a process because that step started a timer. Likewise, selection of a task starts a timer and cannot be “undone” until the study is completed. The observer simply notes the error in the notes field and then corrects the error by editing the time study data file as necessary.

Once a user has obtained a computer program for running on a general purpose hand held touch screen computer, the user will want sets of generic study descriptions, process descriptions, task descriptions, and task characterizations for use with particular types of processes of interest to the user. It is anticipated that venders will offer digital data sets containing these description options for copying by the user into the user's time studies chronometer.

In a preferred embodiment, the software is organized with a primary module that can be run in more than one instance at a time under the selected operating system. A user interface facility is provided to make it easy for the user to launch a second instance of the time study module, which presents a second window, from within the first window display presented by the first instance. By this method, multiple time studies can be conducted at once. For example, where a single observer is observing two different workers, if the workers are not changing tasks too frequently (more frequently than approximately once every four seconds), the observer can switch between the instances to record data for both time studies at once because the use of icons allows the data to be recorded so rapidly. Consequently, the invented system makes it practical for a single observer to conduct two or more time studies at one time.

For running two time studies at once, once the first instance is operational, either before or after the timer has been commenced for the first study, the user instructs the chronometer to commence a second time study which then presents the information for a second study in a second window on the display. Typically, each window will occupy most of the display and the user will have to tap a portion of the display that is not occupied to reveal the window that is hidden. The program keeps track of which time study each item of user input should be entered into by simply entering it into the study where the window is displayed that presents the button selected by the user.

Once the time study is completed, the second major component of the invented system comes to the fore. This component automatically generates reports and analyses using the data that has been collected. It takes advantage of the meta-data created by virtue of the fact that the user selected from pre-specified generic descriptions for the study description, each process description, each task description, and each task characterization. The reports that can be generated are: flow chart, sequence, summary, process, non-value added, projected choke point, average time per task, and work instruction.

FIG. 8 shows a typical report that takes advantage of the meta-data to achieve automatic computations. This report shows the total time for each of four processes within the study, drilling 21, welding 22, clamping 23, and cleaning 24. Two of the processes include non-value added tasks and the time for each of these two processes is broken into value added and non-value added portions. These computations could be performed automatically because, for example in clamping, all of the clamping processes had the same process description, allowing the computer to use the process description to select the process times for each of the clamping processes to compute a total.

Similarly, the system uses the value added or non-value added characterization to break the total time for each process into two parts, as shown in FIG. 8, or add a total of value added or non-value added times.

In addition to simple automatic addition and presentation processing as shown in FIG. 8, the system can use the meta-data to select time durations for tasks or processes or studies having a common description to then compute range of values, distribution of values, standard deviation of values, mean (average), or the median.

FIG. 9 shows another type of report that is particularly useful. By taking advantage of the fact that, for each task, the system now has a task name and description as well as a duration (which might be automatically computed as a mean of observed durations or a median of observed durations or a duration computed using standard deviation methods), all that is required to generate a set of work instructions on a worksheet is to add standard text which is the same for each worksheet and formatting. Consequently, a preferred embodiment of the invented system includes the standard text and formatting and can automatically generate worksheet documents containing work instructions which can be displayed on a display or printed. This is particularly advantageous for companies that seek ISO 9000 certification for manufacturing processes because such certification requires such a work instructions document for many tasks.

A typical work instructions worksheet document generated by the system is shown in FIG. 9, including the standard text 30. In a preferred embodiment, the document includes a space 31 for inserting a digital photograph or drawing of the task being performed, as shown in FIG. 9, or a detail of the work piece. The inspection method key 32 in FIG. 9 shows visual codes used to indicate whether the proper inspection method is visual, by touch, or by instrument (device). One of the visual codes 33 is automatically placed beside the picture or drawing as shown in FIG. 9 based on characterizations observed by the time study analyst.

While details of particular embodiments of the invention have been described, the elements of the invention are not to be defined by such embodiments but rather only by the following claims.

What is claimed is:

1. A time studies chronometer with a changeable display wherein:
(a) for each task of a plurality of observed tasks, the display presents a plurality of generic task description options to describe the task, and
(b) the chronometer accepts input from a user to select one of said task description options for the task.

2. A data carrier containing a computer program which, when run on a general purpose computer, causes the computer to be the chronometer of claim 1.

3. The data carrier of claim 2 wherein the data carrier is a memory device.

4. The data carrier of claim 2 wherein the data carrier is an electronic signal.

5. The chronometer of claim 1 wherein each option is presented on the display with an icon.

6. A data carrier containing a computer program which, when run on a general purpose computer, causes the computer to be the chronometer of claim 5.

7. The chronometer of claim 1 wherein one of the options represents an unknown task and selection of this option by the user allows the user to enter a textual description of the task.

8. A data carrier containing a computer program which, when run on a general purpose computer, causes the computer to be the chronometer of claim 7.

9. The chronometer of claim 1 wherein the option descriptions are loaded into a memory of the chronometer by copying from an external memory coupled to the chronometer.

10. A data carrier containing a computer program which, when run on a general purpose computer, causes the computer to be the chronometer of claim 9.

11. The chronometer of claim 1 wherein the options are presented on a touch screen and the input from a user is accepted from the touch screen.

12. A data carrier containing a computer program which, when run on a general purpose computer, causes the computer to be the chronometer of claim 11.

13. The chronometer of claim 1 wherein data sets collected for each of a plurality of tasks which all have the same generic task description are associated together by the shared task description for subsequent processing together.

14. A data carrier containing a computer program which, when run on a general purpose computer, causes the computer to be the chronometer of claim 13.

15. The chronometer of claim 1 wherein, for time data, the subsequent processing includes one or more of computing the range, distribution, standard deviation, mean, or median.

16. A data carrier containing a computer program which, when run on a general purpose computer, causes the computer to be the chronometer of claim 15.

17. A data carrier containing a plurality of generic task description options to describe a task to be observed in a time study, for copying into a time studies chronometer with a changeable display for presenting the options on the display.

18. The data carrier of claim 17 wherein the data carrier is a memory device.

19. The data carrier of claim 17 wherein the data carrier is an electronic signal.

20. The data carrier of claim 17 wherein each option is presented on the display with an icon.

21. A time studies chronometer with a changeable display wherein:
(a) for each of a plurality of tasks to be observed, the display presents a plurality of generic task characterization options to characterize a task, and
(b) the chronometer accepts input from a user to select one of said task characterization options.

22. A data carrier containing a computer program which, when run on a general purpose computer, causes the computer to be the chronometer of claim 21.

23. The chronometer of claim 21 wherein the options are presented on the display with one or more icons.

24. A data carrier containing a computer program which, when run on a general purpose computer, causes the computer to be the chronometer of claim 23.

25. The chronometer of claim 21 wherein the presented options include a characterization of value added or no value added.

26. A data carrier containing a computer program which, when run on a general purpose computer, causes the computer to be the chronometer of claim 25.

27. The chronometer of claim 21 wherein the presented options include a characterization of a method of inspection wherein the options comprise sight, touch, and device.

28. A data carrier containing a computer program which, when run on a general purpose computer, causes the computer to be the chronometer of claim 27.

29. The chronometer of claim 21 wherein the optional characterizations are loaded into a memory of the chronometer by copying from an external memory coupled to the chronometer.

30. A data carrier containing a computer program which, when run on a general purpose computer, causes the computer to be the chronometer of claim 29.

31. The chronometer of claim 21 wherein data sets collected for each of a plurality of tasks which all received the same characterization are associated together by the characterization for subsequent processing together.

32. A data carrier containing a computer program which, when run on a general purpose computer, causes the computer to be the chronometer of claim 31.

33. A time studies chronometer with a changeable display wherein:
(a) for each series of tasks of a plurality of series of tasks, the display presents a plurality of generic task series description options to describe the task series, and
(b) the chronometer accepts input from a user to select one of said task series description options for the task series.

34. A data carrier containing a computer program which, when run on a general purpose computer, causes the computer to be the chronometer of claim 33.

35. The chronometer of claim 33 wherein each option is presented on the display with an icon.

36. A data carrier containing a computer program which, when run on a general purpose computer, causes the computer to be the chronometer of claim 35.

37. The chronometer of claim 33 wherein one of the options represents an unknown task series and selection of this option by the user allows the user to enter a textual description of the task series.

38. A data carrier containing a computer program which, when run on a general purpose computer, causes the computer to be the chronometer of claim 37.

39. The chronometer of claim 33 wherein the optional descriptions are loaded into a memory of the chronometer by copying from an external memory coupled to the chronometer.

40. A data carrier containing a computer program which, when run on a general purpose computer, causes the computer to be the chronometer of claim 39.

41. The chronometer of claim 33 wherein the options are presented on a touch screen and the input from a user is accepted from the touch screen.

42. A data carrier containing a computer program which, when run on a general purpose computer, causes the computer to be the chronometer of claim 41.

43. The chronometer of claim 33 wherein data sets collected for each of a plurality of task series which all have the same generic task series description are associated together by the shared task series description for subsequent processing together.

44. A data carrier containing a computer program which, when run on a general purpose computer, causes the computer to be the chronometer of claim 43.

45. The chronometer of claim 33 wherein, for time data, the subsequent processing includes one or more of computing the range, distribution, standard deviation, mean, or median.

46. A data carrier containing a computer program which, when run on a general purpose computer, causes the computer to be the chronometer of claim 45.

47. A time studies chronometer with a changeable display wherein:
(a) before commencing a time study, the display presents a plurality of generic study description options to describe the study to be done, and
(b) the chronometer accepts input from a user to select one of said study description options.

48. A data carrier containing a computer program which, when run on a general purpose computer, causes the computer to be the chronometer of claim 47.

49. The chronometer of claim 47 wherein each option is presented on the display with an icon.

50. A data carrier containing a computer program which, when run on a general purpose computer, causes the computer to be the chronometer of claim 49.

51. The chronometer of claim 47 wherein the presented options include an option to continue a prior study.

52. A data carrier containing a computer program which, when run on a general purpose computer, causes the computer to be the chronometer of claim 51.

53. The chronometer of claim 47 wherein the optional descriptions are loaded into a memory of the chronometer by copying from an external memory coupled to the chronometer.

54. A data carrier containing a computer program which, when run on a general purpose computer, causes the computer to be the chronometer of claim 53.

55. The chronometer of claim 47 wherein data sets collected for each of a plurality of time studies which all have the same generic time study description are associated together by the shared time study description for subsequent processing together.

56. A data carrier containing a computer program which, when run on a general purpose computer, causes the computer to be the chronometer of claim 55.

57. The chronometer of claim 47 wherein, for time data, the subsequent processing includes one or more of computing the range, distribution, standard deviation, mean, or median.

58. A data carrier containing a computer program which, when run on a general purpose computer, causes the computer to be the chronometer of claim 57.

59. A time studies chronometer with a changeable display wherein:
(a) for a task series to be observed as part of a time study, the display presents a plurality of task series description options to describe the task series,
(b) upon receipt of input from a user selecting a task series, the display presents a plurality of task description options to describe a task, and
(c) the chronometer accepts input from a user to select one of said task description options for the task.

60. A data carrier containing a computer program which, when run on a general purpose computer, causes the computer to be the chronometer of claim 59.

61. The chronometer of claim 59 wherein the task series description options and the task descriptions are presented on the display with an icon for each description.

62. A data carrier containing a computer program which, when run on a general purpose computer, causes the computer to be the chronometer of claim 61.

63. The chronometer of claim 59 wherein,
(a) before presenting a plurality of task series description options to describe the task series commencing a time study, the display presents a plurality of study description options to describe the study to be done, and
(b) the chronometer accepts input from a user to select one of said study description options.

64. A data carrier containing a computer program which, when run on a general purpose computer, causes the computer to be the chronometer of claim 63.

65. The chronometer of claim 59 wherein the options are presented on a touch screen and the input from a user is accepted from the touch screen.

66. A data carrier containing a computer program which, when run on a general purpose computer, causes the computer to be the chronometer of claim 65.

67. A time studies chronometer with one or more inputs for receiving task designations, task series designations, and mark time events wherein:
(a) input task designations are grouped into a plurality of input task series designations,
(b) mark time events are received designating commencement and finish of tasks,
(c) a mark time event is received designating finish of each of two or more series of tasks, and
(d) for each of the two or more series of tasks, the chronometer measures a time duration.

68. A data carrier containing a computer program which, when run on a general purpose computer, causes the computer to be the chronometer of claim 67.

69. The chronometer of claim 67 wherein the input task designations and task series designations are received from user selection among options represented as icons.

70. A data carrier containing a computer program which, when run on a general purpose computer, causes the computer to be the chronometer of claim 69.

71. The chronometer of claim 67 wherein the input task designations and task series designations are received on a touch screen.

72. A data carrier containing a computer program which, when run on a general purpose computer, causes the computer to be the chronometer of claim 71.

73. The chronometer of claim 67 wherein the input task designations and task series designations are selected from options that present alternative generic descriptions.

74. A data carrier containing a computer program which, when run on a general purpose computer, causes the computer to be the chronometer of claim 73.

75. A method in a time studies chronometer for capturing inspection method data for one or more tasks, comprising the steps of:
(a) receiving a mark time event designating commencement of a task,
(b) receiving inspection method data input on the chronometer;
(c) receiving a mark time event designating finish of the task, and
(d) storing in a memory said inspection method data and, associated with said inspection method data, time data indicating duration of the task.

76. A data carrier containing a computer program which, when run on a general purpose computer, causes the computer to perform the method of claim 75.

77. The method of claim 75 wherein the input inspection method is received from user selection from pre-specified options for inspection methods.

78. A data carrier containing a computer program which, when run on a general purpose computer, causes the computer to perform the method of claim 77.

79. The method of claim 77 wherein the pre-specified options for inspection methods are presented to a user as icons displayed on a display of the chronometer.

80. A data carrier containing a computer program which, when run on a general purpose computer, causes the computer to perform the method of claim 79.

81. The chronometer of claim 77 wherein the pre-specified options for inspection methods comprise sight, touch, and device.

82. A data carrier containing a computer program which, when run on a general purpose computer, causes the computer to perform the method of claim 81.

83. A method in a time studies chronometer system for generating a work sheet for a task, comprising the steps of:
(a) receiving standard text for presentation on a worksheet;
(b) receiving a task name and description for a task;
(c) receiving a mark time event designating commencement of the task;
(d) receiving a mark time event designating finish of the task;
(e) storing in a memory said task name and description and, associated with said task name and description, time data indicating duration of the task; and
(f) generating data representing a worksheet document for the task comprising the standard text, the task name and description, and duration of the task.

84. A data carrier containing a computer program which, when run on a general purpose computer, causes the computer to perform the method of claim 83.

85. The method of claim 83 further comprising receiving an indication of an inspection method for the task, associating said inspection method indication with the task, and including an indication of the inspection method in said worksheet document.

86. A data carrier containing a computer program which, when run on a general purpose computer, causes the computer to perform the method of claim 85.

87. The method of claim 83 further comprising receiving digital photographic data, associating said photographic data with the task, and including said photographic data in said worksheet document.

88. A data carrier containing a computer program which, when run on a general purpose computer, causes the computer to perform the method of claim 87.

89. A method in a software based time studies chronometer with a display and a multi-tasking operating system for simultaneously capturing data for two or more time studies, comprising the steps of:
(a) receiving user input instructing the time studies chronometer to commence a first time study and, in response, running a first instance of a time study software module which presents information in a first window on the display;
(b) while the first instance remains operational, receiving user input instructing the time studies chronometer to commence a second time study and, in response, running a second instance of a time study software module which presents information in a second window on the display;
(c) upon receipt of user input designating one of the windows, causing the display to present the information of the designated window; and
(d) while the first window is displayed, entering mark time events received by the chronometer in a data record for the first time study and, while the second window is displayed, entering mark time events received by the chronometer in a data record for the second time study.

90. A data carrier containing a computer program which, when run on a general purpose computer, causes the computer to perform the method of claim 89.

91. The method of claim 89 wherein the display is also a touch screen and the user input is received at the touch screen.

92. A data carrier containing a computer program which, when run on a general purpose computer, causes the computer to perform the method of claim 91.

93. The method of claim 89 wherein the chronometer is a palm-top general purpose computer.

94. A data carrier containing a computer program which, when run on a general purpose computer, causes the computer to perform the method of claim 93.
